(19) United States
(12) Patent Application Publication
(10) Pub. No.: US 2005/0146824 A1
(43) Pub. Date: Jul. 7, 2005

(54) Active Safety Circuit with Loads Protected by Solid State Relays

(75) Inventor: Carles Borrego Bel, Valls (ES)

Correspondence Address: Bruce E. Harang, PO BOX 872735, VANCOUVER, WA, 98687-2735, US

(73) Assignee: LEAR CORPORATION, Southfield, MI (US)

(21) Appl. No.: 10/707,642

(22) Filed: Dec. 29, 2003

(51) Int. Cl. H02H 5/04

(52) U.S. Cl. 361/103

(57) ABSTRACT

An active safety circuit with loads protected by solid state relays comprising several solid state relays (1, 2, 3) supplying loads, controlled in turn from a microcontroller (4) for opening said relays (1, 2, 3) in the case of an anomaly in said loads, comprising a fuse (5) inserted in a supply network (6) of relays (1, 2, 3) and a grounded shunt line (7) from one point (8) of the network (6) between said fuse (5) and relays (1, 2, 3), and a safety switch (9) controlled by said microcontroller (4) and inserted in the line (7). A temperature detector (10) is either associated to each relay (1, 2, 3) or is commonly shared by several of said relays (1, 2, 3), and the detector (19) is connected to the microcontroller (4).

### BACKGROUND OF INVENTION

1. Field of the Invention

The present invention concerns electronic safety devices with loads protected by solid state relays, such as field-effect transistor (FET) type switches controlled by microcontroller.

The interest of the proposed safety circuit derives from the current tendency to increase the number of controlled FET type switches, for protecting various loads, for example in automobile electronics.

However, one of the faults of this type of switches, particularly given the nature of the semi-conducting material constituting them, is the particular behaviour of said switches in the way of a shunt resistance with a resistance considerably greater than the nominal resistance (although not as high as that which an open circuit would impose), which causes a significant increase in the temperature of the FET device by dissipation, possibly entailing its destruction and potentially fire and damage to the safety circuit substrate.

2. Background of the Invention

European Patent EP-A-0148370 discloses a safety circuit of an automobile vehicle for protecting an electronic circuitry assembled thereon against an overload coming from the power supply. To this end, said circuit is provided with a fuse inserted in the feeder, a grounded shunt line with an inserted switching transistor connected to said feeder substantially at a point between the fuse and the circuit to be protected. An operational amplifier monitors the voltage in the feeder so that this does not exceed a certain threshold. Also analogically, said amplifier acts on said switching transistor to short-circuit said feeder to ground and to immediately blow the fuse so as to leave the circuit to be protected in open circuit if the threshold has been exceeded.

The object of the present invention is primarily to prevent overheating with the risk of fire of said group of FET type switches. Indeed, in an indirect manner, the loads or sub-circuits controlled by said FET type switches are also protected against a possible short circuit, ensuring that in case of failure of the FET type switch, this will not be destroyed and the load will not suffer damage.

Although the structure of the protection circuit proposed herein is also based on a shunt circuit with a fuse and a controlled safety switch, the control and monitoring is digital and is not carried out with respect to an overload in the feeder, but is carried out according to the integrity of said FET type switches, measured through its temperature.

To this end, temperature detectors connected to the same microcontroller controlling the FET type switches in its normal operating mode and to which a simple algorithm is incorporated according to the methodology of the present invention, are provided to maintain the grounded shunt line open or to short-circuit it, acting on the safety switch at the appropriate time. Furthermore, unlike the analogue control which is usually of fixed response, digital control conditions allow the use of a microcontroller and provide the advantage whereby said control can be more “intelligent”, capable if necessary of providing for more parameters and variants in the decision process. An example of this potential will be shown below.

### BRIEF DESCRIPTION OF THE INVENTION

As previously indicated, one of the faults that can occur with FET type switches is that of providing in determined cases a higher impedance than the nominal impedance in conduction (although not as high as in open circuit). In conduction, the current is fixed by the loads, therefore when increasing the impedance of the FET type switches, the dissipated power therein increases together with its temperature, with the consequent risk of fire on the substrate of the circuit housing the FET type switches.

In keeping with the operations for implementing this invention, after the first detection of temperature increase in at least one of the switches, the microcontroller places said switch in open circuit, waits a certain time to see if the anomaly has disappeared, and if this persists, the microcontroller orders the short-circuiting of the shunt circuit, so as to provoke complete opening and isolation from the circuit of the group of FET type switches and their loads dependent on the power supply. This constitutes a good example of the “intelligence” which provides the control with use of digital control rather than analogue control such as that discussed in the background above.

The features of the invention will be made clearer with the help of a description thereof by means of several embodiments.

### BRIEF DESCRIPTION OF DRAWINGS

In said drawings:

FIG. 1 shows a schematic view showing one embodiment of the proposed safety circuit including a temperature detector associated to a series of solid state relays connected to respective loads, said temperature detector being connected to a microcontroller.

FIG. 2 shows an alternative embodiment wherein each solid state relay is provided with a dedicated temperature detector.

### DETAILED DESCRIPTION

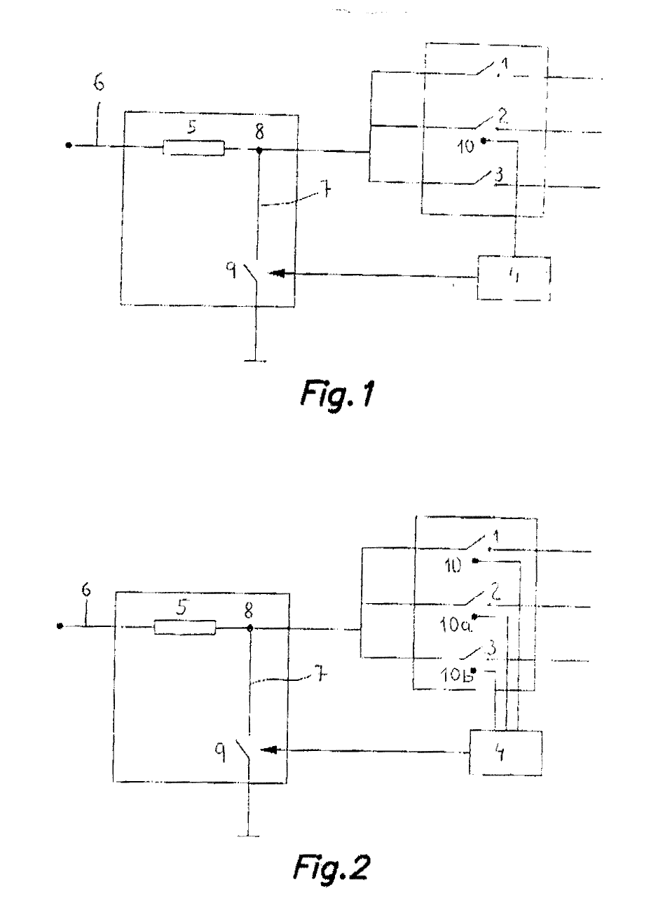

As the mentioned figures show, the active safety circuit with loads protected by solid state relays of the invention generally comprises a group of loads (not shown) fed through solid state relays 1, 2, 3 (schematised by means of a switch), controlled in turn from a unit such as a microcontroller 4 which is prepared for provoking the opening of said relay(s) 1, 2 and 3, in case an anomaly should occur in said loads, comprising a current breaking device 5 inserted in a power supply network 6 to said solid state relay(s) 1, 2, 3 and a grounded shunt line 7 from point 8 of said power supply network, placed between the breaking device 5 and said solid state relay(s) 1, 2, 3, and a safety switch 9 governed by said microcontroller 4 and inserted in said grounded shunt line 7. According to the principles of the invention, a temperature detector 10 is provided, either associated to each solid state relay 1, 2, 3 (example of FIG. 2) or commonly shared by several of said solid state relays 1, 2, 3 (example of FIG. 1), and connected to said microcontroller 4.

Operation of the circuit is as follows: the microcontroller 4 sequentially checks the state of said temperature detector 10 or detectors 10, 10a, 10b to open, if an anomaly in temperature is produced, the corresponding solid state relays 1, 2, 3 (in the case of a dedicated detector being used for each relay 1, 2, 3) and, if the problem persists, to close said controlled safety switch 9, so as to short-circuit to ground said power supply network 6 by means of the grounded shunt line 7, actuating said breaking device 5 and thus provoking the disconnection of said solid state relay and its corresponding set of associated loads, with respect to a power source.

In a preferred embodiment of the invention, said solid state relays are constituted on the basis of an FET switch controlled by said microcontroller 4.

For its part, said breaking device 5 will generally be a fuse (duly sized such that the passage of an overcurrent (exceeding a pre-fixed threshold) through it causes it to blow).

If controlled, said safety switch 9 could be an electronic power switch, particularly of the FET type or a power relay.

1. An active safety circuit with loads protected by solid state relays, of the type wherein a load or a group of loads is fed through at least one solid state relay controlled in turn from a unit such as a microcontroller prepared for provoking the opening of said relay, which is at least one, in case an anomaly occurs in said loads, comprising: a current breaking device inserted in the power supply network of said solid state relay, which is at least one, a grounded shunt line from one point of said supply network, placed between said fuse and said solid state relay, and a safety switch controlled by said microcontroller and inserted in said grounded shunt line, characterized by comprising a set of at least one temperature detector associated to said solid state relay, which is at least one, and connected to said microcontroller such that the latter sequentially checks the state of said temperature detector to open, if an anomaly in temperature is produced, the corresponding solid state relay and, if the problem persists, to close said controlled safety switch so as to short-circuit to ground said power supply through said grounded shunt line, actuating said breaking device, thereby provoking the disconnection of said solid state relay and its corresponding set of associated loads, with respect to a power source.

2. A safety circuit according to claim 1, characterized in that said solid state relay is an FET switch controlled by said microcontroller.

3. A safety circuit according to claim 2, characterized in that said breaking device is a fuse, so that the passage of an overcurrent through it causes it to blow.

4. A safety circuit according to claim 3, characterized in that each load has an FET protection switch associated to it, and each one of these switches has a dedicated temperature detector.

5. A safety circuit according to claim 1, characterized in that various loads have a single associated FET protection switch, and the latter has a dedicated temperature detector.

6. A safety circuit according to claim 1, characterized in that said controlled safety switch is an electronic power switch.

7. A safety circuit according to claim 1, characterized in that said controlled safety switch is of the FET type.

8. A safety circuit according to claim 1, characterized in that said controlled safety switch is a relay.
